(19) United States
(12) Patent Application Publication
(10) Pub. No.: US 2002/0118680 A1
(43) Pub. Date: Aug. 29, 2002

(54) Media router and method for recording/reproducing broadcasting signal by using the same

(76) Inventor: Sang Yong Lee, Seoul (KR)

Correspondence Address: BIRCH STEWART KOLASCH & BIRCH, PO BOX 747, FALLS CHURCH, VA, 22040-0747, US

(21) Appl. No.: 10/084,447

(22) Filed: Feb. 28, 2002

(30) Foreign Application Priority Data
Feb. 28, 2001 (KR) P2001-10320

(51) Int. Cl. H04L 12/66

(52) U.S. Cl. 370/389; 370/352

(57) ABSTRACT

Media router for coding not only a digital TV broadcasting but also an analog broadcasting into MPEG-2 TS, and storing in a storage medium, including a media routing control part for giving a fixed unit of time stamp, a TS packet number, to every TS packet of a TS (Transport Stream) of a digital broadcasting or an analog broadcasting signal, and extracting index information from the TS having the time stamp added thereto, a storage part for receiving the TS having the time stamp added thereto and the index information from the media routing control part and storing therein, and a decoding part for receiving, decoding, and displaying the received broadcasting signal or a signal reproduced through the storage medium and the media routing control part, thereby permitting a trick reproduction at a desired multiple rate, like a VCR, and simultaneous recording and reproduction. Moreover, the time stamp given to every TS packet in the storage in the storage medium for supporting the trick mode reproduction simplifies a hardware system.

This application claims the benefit of the Korean Application No. P2001-10320 filed on Feb. 28, 2001, which is hereby incorporated by reference.

### BACKGROUND OF THE INVENTION

1. Field of the Invention

The present invention relates to a media router, and a method for recording reproducing a broadcasting signal by using the same.

2. Background of the Related Art

A PDR (Personal Digital Recorder), storing analog broadcasting, as well as digital broadcasting stream in a storing medium, and reproducing the stored data from the storing medium, is required to support coding and storing the analog broadcasting into MPEG-2 TS (Moving Picture Expert Group-2 Transport Stream) taking coexistence of DTV broadcasting and the analog broadcasting, such as NTSC into account.

The MPEG-2 defines three forms of I, P, and B pictures. The I picture is coded by simply subjecting the picture to DCT (Discrete Cosine Transform) without any motion compensation, and the P picture is subjected to motion compensation with reference to the I picture or other P picture, and DCT for a remained portion after the motion compensation. Though the B (bidirectionally predicted-coded) picture uses motion compensation like the P picture, different from the P picture, the B picture is subjected to motion compensation with reference to front and rear two frames on a time axis. Accordingly, the MPEG-2 has a picture sequence of —, B, B, I, B, B, P, B, B, P, B, B, —, wherein a group of pictures starting from the B picture two pictures before the I picture to the P picture before the next I picture with reference to an order of display is called as GOP (Group Of Pictures). In the meantime, with reference to an order of transmission, the GOP starts from the I picture to a picture before the next I picture. When it is assumed that ‘N’denotes a number of pictures in the GOP, and ‘M’ denotes a number of pictures between the I and P pictures, or between the P and P pictures, ‘N’ and ‘M’ vary within a sequence. The MPGE-2 TS has packets each having 188 bytes with a 4 byte packet header.

Moreover, the PDR is required to support a variety of trick mode plays (for an example, fast forward, fast backward, stop, instant replay, sync play, and the like) that a VCR (Video Cassette Recorder) supports for stored TS.

In the related art, the support to a trick reproduction mode for the stored TS is processed by software. However, because there are a limit in processing every thing by software, and difficulty in view of technique.

### SUMMARY OF THE INVENTION

Accordingly, the present invention is directed to a media router, and a method for recording/reproducing a broadcasting signal by using the same that substantially obviates one or more of the problems due to limitations and disadvantages of the related art.

An object of the present invention is to provide a media router, and a method for recording/reproducing a broadcasting signal by using the same, which can make hardware basis trick reproduction mode support.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the media router includes a media routing control part for giving a fixed unit of time stamp, a TS packet number, to every TS packet of a TS (Transport Stream) of a digital broadcasting or an analog broadcasting signal, and extracting index information from the TS having the time stamp added thereto, and a storage part for receiving the TS having the time stamp added thereto and the index information from the media routing control part and storing therein.

The media routing control part includes a multiplexer for selecting and forwarding one of the TSs of the digital broadcasting signal and the analog broadcasting signal, a format converting part for giving a time stamp to the TS from the multiplexer to synchronize, and extracting index information, a demultiplexer for selecting one of outputs of the multiplexer and the format converting part, and a scrambling/descrambling part for scrambling the TS having the time stamp given thereto and the index information or descrambling scrambled information from the storage part.

The storage part includes a system memory for storing the TS and the index information from the media routing control part, and a storage medium for receiving the TS and the index information stored in the system memory and storing the TS and the index information, again.

In another aspect of the present invention, there is provided a media router including a PID filter part for selecting only a TS of a desired program from a received digital broadcasting signal and forwarding the TS, an MPEG-2 encoder for coding a received analog broadcasting signal into an MPEG-2 TS format, and forwarding the coded analog broadcasting signal, a media routing control part for giving a time stamp to every TS packet from the PID filter part or every TS packet of the analog broadcasting signal from an MPEG-2 encoder to, synchronize the TS packet, and extracting index information, a memory part for storing the TS synchronized at the media routing control part and the index information, and a decoding part for receiving, decoding, displaying a broadcasting signal or a signal reproduced through the memory part, and the media routing control part.

The TS and the index information stored in the system memory is stored in the storage medium by DMA (Direct Memory Access) transmission, and the TS and the index information from the media routing control part are stored in the storage part through a PCI bus.

The index information includes at least one of the TS packet number having a picture header and information on kind of picture.

In further aspect of the present invention, there is provided a method for recording a broadcasting signal by using a media router having a media routing control part and a storage medium, comprising the steps of (a) selecting one of TSs of a received digital broadcasting signal and a received analog broadcasting signal, (b) adding a time stamp to a selected TS to synchronize, and extracting index information, for converting a format of the TS, and (c) storing the TS having the time stamp added thereto and the index information in a storage medium.

The method further includes the steps of determining whether a format converted TS is scrambled or not, and scrambling and storing the TS if the TS is to be scrambled as a result of the determination, and storing the TS without scrambling the TS if the TS is not to be scrambled as a result of the determination.

The method further includes the step of setting a password at the storage medium to inhibit recording/reproduction after the step (c).

In still further aspect of the present invention, there is provided a method for reproducing a broadcasting signal by using a media router having a media routing control part and a storage medium, including the steps of (a) converting formats of a time stamp and index information stored in the storage medium or a format of the TS only, and (b) decoding, and displaying a format converted TS.

The step (a) includes the step of descrambling the TS before the format conversion, if the TS stored in the storage medium is in a scrambled state.

The step (a) includes the step of converting a format of only a TS packet from the storage medium, with reference to the TS packet number, kind of picture, and the time stamp given to every TS packet in the index information stored in the storage medium, when a trick mode reproduction is to be carried out.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a block diagram of a media router in accordance with a preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

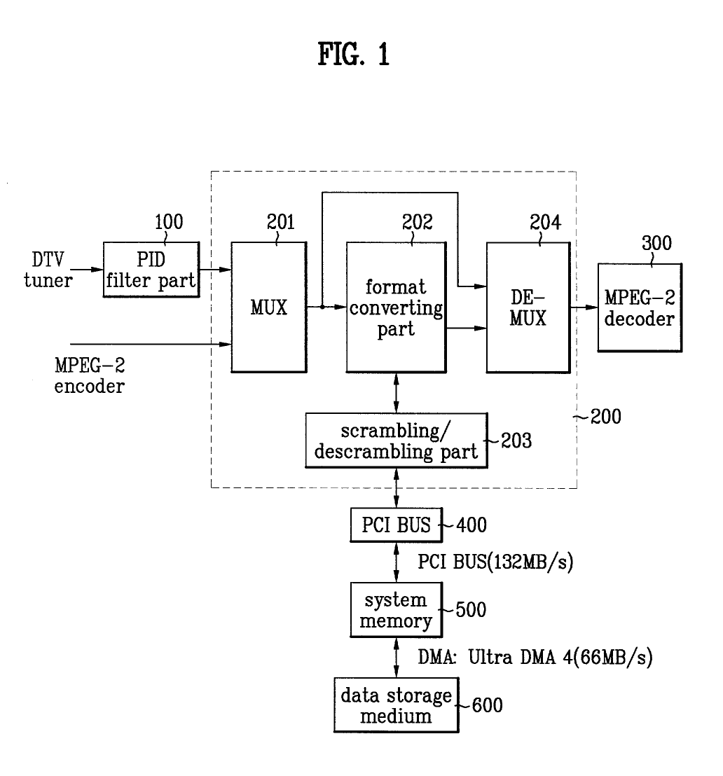

The present invention suggests to make hardware basis trick reproduction mode support in coding, not only a DTV broadcasting, but also NTSC broadcasting, by MPEG-2 and storing in a storing media. For convenience of description, such hardware is call as a media router. FIG. 1 illustrates a block diagram of a media router in accordance with a preferred embodiment of the present invention.

Referring to FIG. 1, the media router includes a PID filter part 100 for parsing a PSI (Program Information) from a bitstream from a DTV tuner, detecting a PID (Program Identification), and selecting and forwarding only a program a watcher desires, a media routing control part 200 for giving a time stamp to every TS packet from the PID filter part 100 or every TS packet of the analog broadcasting signal from an MPEG-2 encoder to, synchronize the TS packet, and extracting index information, a system bus (hereafter called as a PCI bus) 400 for transmitting a TS synchronized at the media routing control part 200 and the index information, a system memory 500 for storing the TS and the index information from the PCI bus 400, and a storage medium 600 for receiving the TS and the index information stored in the system memory 500 by DMA (Direct Memory Access) transmission and storing the TS and the index information.

In this embodiment, a storage medium a random access thereto is permitted, such as an HDD (Hard Disc Drive) or a DVD (Digital Versatile Disc), is employed as the storage medium 600.

The media routing control part 200 includes a multiplexer 201, a selecting part, for selecting and forwarding one of the TSs from the PID filter part 100 or the MPEG-2 encoder, a format converting part 202 for giving a time stamp to the TS from the multiplexer 201 to synchronize, and extracting index information, scrambling/descrambling part 203 for scrambling an output of the format converting part 202 or descrambling a reproduced signal if the reproduced signal is scrambled, and a demultiplxer 204 for selecting one of outputs of the multiplexer 201 and the format converting part 203.

The foregoing media router receives the digital broadcasting and the analog broadcasting, selectively. That is, the media routing control part 200 receives the TS of the digital broadcasting through the DTV tuner and PID filter part 100, and the TS of the analog broadcasting through the MPEG-2 encoder. That is, the analog broadcasting signal is coded into an MPEG-2 TS at the MPEG-2 encoder and provided to the media routing control part 200.

The PID filter part 100 parses PSI from a bitstream of a channel from the DTV tuner, and detects a PID therefrom. The channel tuned at the DTV tuner may have multiple programs multiplexed therein, when a TS of a desired program is provided to the media routing control part 200 by using the PID. Since an analog broadcasting, such as an NTSC, has only one program on one channel, no PID detection is required.

The multiplexer 201 in the media routing control part 200 selects one of the TSs of the PID filter part 100 or the MPEG-2 encoder, and provides to the format converting part 202 and the demultiplexer 204.

For supporting a trick mode, the format converting part 202 either converts a format of the TS from the multiplexer 201 and provides to the storage medium 600, or converts the TS reproduced from the storage medium 600 suitable for display, and provides to the demultiplexer 204.

The demultiplexer 204 selects one of the TSs of the multiplexer 201 and the format converting part 202, and provides to the MPEG-2 decoder 300.

That is, when it is intended to receive and display a broadcasting signal on a TV screen, the demultiplexer 204 selects the TS form the multiplexer 201 and provides to the MPEG-2 decoder 300, and when it is intended to display a broadcasting signal stored in the storage medium 600, the demultiplexer 204 selects the TS from the format converting part 202 and provides to the MPEG-2 decoder 300.

The MPEG-2 decoder 300 receives a video stream, removes overheads (various header information, start codes, and the like) from the video bitstream, and provides to a display after pixel values of an original picture are restored by subjecting to inverse quantization, IDCT (Inverted Discrete Cosine Transform), and motion compensation by using a motion vector, after subjecting pure data information to VLD (Variable Length Decoding).

In the meantime, in a case of recording and display when recording and display of a received broadcasting signal are carried out on the same time, the demultiplexer 204 selects the broadcasting signal from the multiplexer 201 and provides to the MPEG-2 decoder 300 and, on the same time, the format converting part 202 converts a format of the broadcasting signal from the multiplexer 201 and stores in the storage medium 600. In this instance, the time stamp is given to all TS packets of the TS from the PID filter part 100 or the MPEG-2 encoder, starting from ‘0’, to make the time stamp to be a TS packet number. For one example, if the time stamp has a four byte size, a 188 byte TS packet becomes to have 192 byte when stored in the storage medium 600.

In order to make the trick mode reproduction to be supported in a fixed picture unit (GOP, or P picture unit), the format converting part 202 extracts index information from the TS having the time stamp added thereto, and stores in the storage medium 60, together with the TS having the time stamp added thereto. In this instance, the index information is stored in the storage medium 600 separate from the TS having the time stamp added thereto. The index information includes information, such as a TS packet number including a picture header, kind of pictures (I, B, and P pictures or a sequence start), and the like. The time stamp is used as the TS packet number.

In the meantime, the TS converted into a format with which the user desires to store at the media routing control part 200 may be scrambled if the user desires.

If the user does not desire the scrambling, the TS having the time stamp given thereto by a synchronization process at the format converting part 202 and the index information bypasses the scrambling/descrambling part 203, is stored in the system memory 500 through a PCI (Peripheral Component Interconnect) bus 400 once, and stored in the storage medium 600 by the DMA (Direct Memory Access) which requires no intervention from a CPU, finally. That is, the storage medium 600 stores unscrambled TSs, time stamps each given to every packet, and the index information.

If the user desires the scrambling, the TS having the time stamp given thereto by a synchronization process at the format converting part 202 and the index information is scrambled at the scrambling/descrambling part 203, stored in the system memory 500 through the PCI bus 400 once, and stored in the storage medium 600 by transmission of the DMA, finally. That is, the storage medium 600 has the scrambled TSs, the time stamps given to every TS packet, and the index information. The scrambling may be selected at the users' option, or the system may be designed to select the scrambling, automatically.

Since the digital broadcasting stream is a signal occupying a large bandwidth, a bandwidth of the digital broadcasting stream in a case of reproduction is required to be taken into account. That is, in order to secure a PCI bus bandwidth, the digital broadcasting stream is transmitted, for an example, at a transmission rate of an ultra DMA mode 4 (66 MB/s) when the digital broadcasting stream is transmitted from the system memory 500 to the storage medium 600.

When a security of additional level is required, the storage into the storage medium 600 may be inhibited by using a security set password function of the storage medium 600, if the storage medium 600 has the security set password function.

In the meantime, a data transmission path in a case the TS stored in the storage medium 600 is reproduced is reverse of the storage process. That is, the TS is transmitted, from the storage medium 600 to the system memory 500, from the system memory 500 to the media routing control part 200, and from the media routing control part 200 to the MPEG-2 decoder 300, for reproduction on a TV screen.

If the TS to be reproduced is in a scrambled state, the TS is descrambled at the scrambling/descrambling part 203, and provided to the format converting part 202, and the format converting part 202 converts a format of the TS to be reproduced into a format suitable for the display, and provides to the MPEG-2 decoder 300 through the demultiplexer 204. If the TS to be reproduced is not in the scrambled state, the TS to be reproduced bypasses the scrambling/descrambling part 203 and is forwarded to the format converting part 202.

When the stored TS is read from the storage medium 600, the reproduction may also be inhibited by using the security set password function described in the storage from the beginning. When a data is transmitted from the storage medium 600 to the system memory 500, the transmission rate of ultra DMA mode 4 is used like the storage process.

In the trick mode reproduction, the TS is read from the storage medium 600 in a fixed picture unit (GOP or P picture unit) by using the index information and the time stamp stored in the storage medium 600 together with the TS, and Is provided to the system memory 500. That is, among pictures transmitted to the MPEG-2 decoder 300 by using index information and the time stamp, a part of the pictures are passed or repeated in carrying out the trick mode reproduction. Since the media router of the present invention has the time stamp, a TS packet number, given to each TS packet, and the index information on kind of picture, the TS packet number, only a desired unit of pictures can be read. For an example, if it is intended to select and forward only the P pictures, what is required is to read only the TS packet of the packet number of the TS stream for the P picture from the storage medium 600.

As has been explained, the media router and the method for recording reproducing a broadcasting signal by using the same have the following advantages.

The employment of an HDD or DVD, which permits random access, as a medium for storing a broadcasting stream permits a trick reproduction at a desired multiple rate, like a VCR, and simultaneous recording and reproduction. A scheduled recording is also made possible when guide information like EPG is used. When the storage medium supports the security set password function, inhibition of data writing/reading to/from the storage medium is made possible, permitting additional personal data protection on top of the data scrambling. In this instance, besides the inhibition of data writing/reading to/from the storage medium, since scrambling of contents itself is made possible, two stages of data protection mechanism is applicable.

Especially, the time stamp given to every TS packet in storage in the storage medium for supporting the trick mode makes a simple hardware system. As there is almost no data to be stored in the storage medium except the TS and the index information, and the TS does not require storage in the storage medium as a program stream (PS), no software and hardware required for format conversion to the PS is required.

Application of the media router of the present invention to the PDR permits to improve an overall performance of the PDR.

It will be apparent to those skilled in the art that various modifications and variations can be made in the media router, and the method for recording/reproducing a broadcasting signal by using the same of the present invention without departing from the spirit or scope of the invention. Thus, it is intended that the present invention cover the modifications and variations of this invention provided they come within the scope of the appended claims and their equivalents.

What is claimed is:

1. A media router comprising:
a media routing control part for giving a fixed unit of time stamp, a TS packet number, to every TS packet of a TS (Transport Stream) of a digital broadcasting or an analog broadcasting signal, and extracting index information from the TS having the time stamp added thereto; and,
a storage part for receiving the TS having the time stamp added thereto and the index information from the media routing control part and storing therein.

2. A media router as claimed in claim 1, wherein the media routing control part includes;
a multiplexer for selecting and forwarding one of the TSs of the digital broadcasting signal and the analog broadcasting signal,
a format converting part for giving a time stamp to the TS from the multiplexer to synchronize, and extracting index information, and
a demultiplxer for selecting one of outputs of the multiplexer and the format converting part.

3. A media router as claimed in claim 2, further comprising a scrambling/descrambling part for scrambling the TS having the time stamp given thereto and the index information or descrambling scrambled information from the storage part.

4. A media router as claimed in claim 1, wherein the TS and the index information from the media routing control part are stored in the storage part through a PCI bus.

5. A media router as claimed in claim 1, wherein the storage part includes;
a system memory for storing the TS and the index information from the media routing control part, and
a storage medium for receiving the TS and the index information stored in the system memory and storing the TS and the index information, again.

6. A media router as claimed in claim 5, wherein the TS and the index information stored in the system memory is stored in the storage medium by DMA (Direct Memory Access) transmission.

7. A media router as claimed in claim 5, wherein the storage medium is either an HDD (Hard Disc Drive) or a DVD (Digital Versatile Disc).

8. A media router as claimed in claim 1, wherein the index information includes at least one of the TS packet number having a picture header and information on kind of picture.

9. A media router comprising;
a PID filter part for selecting only a TS of a desired program from a received digital broadcasting signal and forwarding the TS;
an MPEG-2 encoder for coding a received analog broadcasting signal into an MPEG-2 TS format, and forwarding the coded analog broadcasting signal;
a media routing control part for giving a time stamp to every TS packet from the PID filter part or every TS packet of the analog broadcasting signal from an MPEG-2 encoder to, synchronize the TS packet, and extracting index information;
a memory part for storing the TS synchronized at the media routing control part and the index information, and
a decoding part for receiving, decoding, displaying a broadcasting signal or a signal reproduced through the memory part, and the media routing control part.

10. A media router as claimed in claim 9, wherein the media routing control part includes;
a multiplexer for selecting and forwarding one of the TSs of the digital broadcasting signal and the analog broadcasting signal,
a format converting part for giving a time stamp to the TS from the multiplexer to synchronize, and extracting index information,
a demultiplxer for selecting one of outputs of the multiplexer and the format converting part, and
a scrambling/descrambling part for scrambling the TS having the time stamp given thereto and the index information or descrambling scrambled information from the storage part.

11. A media router as claimed in claim 9, wherein the storage part includes;
a system memory for storing the TS and the index information from the media routing control part, and
a storage medium for receiving the TS and the index information stored in the system memory and storing the TS and the index information, again.

12. A media router as claimed in claim 11, wherein the TS and the index information stored in the system memory is stored in the storage medium by DMA (Direct Memory Access) transmission.

13. A media router as claimed in claim 9, wherein the TS and the index information from the media routing control part are stored in the storage part through a PCI bus.

14. A media router as claimed in claim 9, wherein the index information includes at least one of the TS packet number having a picture header and information on kind of picture.

15. A method for recording a broadcasting signal by using a media router having a media routing control part and a storage medium, comprising the steps of:
(a) selecting one of TSs of a received digital broadcasting signal and a received analog broadcasting signal;
(b) adding a time stamp to a selected TS to synchronize, and extracting index information, for converting a format of the TS; and,
(c) storing the TS having the time stamp added thereto and the index information in a storage medium.

16. A method as claimed in claim 15, further comprising the steps of:
determining whether a format converted TS is scrambled or not; and,
scrambling and storing the TS if the TS is to be scrambled as a result of the determination, and storing the TS without scrambling the TS if the TS is not to be scrambled as a result of the determination.

17. A method as claimed in claim 15, further comprising the step of setting a password at the storage medium to inhibit recording/reproduction after the step (c).

18. A method for reproducing a broadcasting signal by using a media router having a media routing control part and a storage medium, comprising the steps of:
(a) converting formats of a time stamp and index information stored in the storage medium or a format of the TS only; and,
(b) decoding, and displaying a format converted TS.

19. A method as claimed in claim 18, wherein the step (a) includes the step of descrambling the TS before the format conversion, if the TS stored in the storage medium is in a scrambled state.

20. A method as claimed in claim 18, wherein the step (a) includes the step of converting a format of only a TS packet from the storage medium, with reference to the TS packet number, kind of picture, and the time stamp given to every TS packet in the index information stored in the storage medium, when a trick mode reproduction is to be carried out.
